(19) United States
(12) Patent Application Publication
(10) Pub. No.: US 2008/0093313 A1
(43) Pub. Date: Apr. 24, 2008

(54) STORAGE RACK

(75) Inventor: Bernhard Huber, Kappelrodeck (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: KEURO BESITZ GMBH & CO. EDV-DIENSTLEISTUNGS KG, Achern (DE)

(21) Appl. No.: 11/876,196

(22) Filed: Oct. 22, 2007

(30) Foreign Application Priority Data
Oct. 23, 2006 (DE) 202006016309.3

(51) Int. Cl. B25H 3/04

(52) U.S. Cl. 211/1.51; 211/187

(57) ABSTRACT

A storage rack for flat-shaped stock (4) is provided having at least one rack unit (2) which has several rack compartments arranged above one another to receive the stock (4). A rack control unit controls placement of the stock in storage or its removal. The rack control unit is arranged to be vertically adjustable relative to the rack unit and has a lifting mechanism (6) for vertical adjustment. The lifting mechanism (6) has at least one bar (7, 8) extending generally in a vertical direction, allocated to the rack unit (2), and a drive wheel (9) allocated to the vertically adjustable rack control unit, and the drive wheel (9) interacts with the bar (7, 8) via a drive gear.

### BACKGROUND

The invention relates to a storage rack for, in particular, flat-shaped stock having at least one rack which has several rack shelves to accommodate the stock, and having at least one rack control unit for removing stock from storage or placing it in storage, whereby the rack control unit is arranged relative to the rack so as to be vertically adjustable and that it has a lifting mechanism for the vertical adjustment.

There are various embodiments for storage racks with a lifting mechanism in the prior art, however, the lifting mechanisms usually used, especially for heavy stock, have ropes, yet almost without exception a chain drive in which the rack control unit comprises a crosspiece extending parallel to the storage rack, suspended on two chains.

However, chain drives, for example with roller chains, have various disadvantages which can all be attributed to the multi-link structure: On the one hand, chains of this type have a run-in elongation since, with larger loads, the chain parts linearly coming into contact (in particular bolts and chain bushings) first adapt the mutual radii to one another. The length of a chain element changes only minimally as a result of this, however, these minimal changes add up over the entire length of the chain (which are often in the two-digit meter range) to form a clear change in length which requires a readjustment.

Similarly, the chain is also affected in dependency on the force of the weight of the stock which is to be handled by it; if a chain is relieved of the load in a rack after the stock item has been stored, then the crosspiece between the two chains usually jumps a little upward to a height level which is even a few centimeters above the level of the crosspiece in the loaded condition. This load elongation must also be compensated accordingly or at least taken into consideration when working with the chain drive.

For this reason, chain drives of this type are usually provided with external positioning systems which determine the exact height position in comparison to the storage rack independent of the load condition and of any possible run-in elongation or any other wear.

Thus, chains have the essential disadvantages of an elastic elongation in dependency on the load condition, a run-in elongation, manufacturing tolerances which add up over the entire chain length and comparatively extensive wear.

### SUMMARY

Thus, the object of the present invention is to provide a storage rack of the aforementioned type which is distinguished by a lifting mechanism which operates without a chain drive and yet is able to handle stock with larger weight forces in a more accurate positioning manner.

According to the invention, this object is met in that the lifting mechanism has at least one profiled bar, which extends essentially in a vertical direction, allocated to the rack unit and a drive wheel allocated to the vertically adjustable rack control unit, and that the drive wheel interacts with the bar via a drive gear.

In the prior art, the great disadvantages are caused, above all, by the multi-link chain construction having a plurality of chain elements connected in series, whereby small gaps, which enable the movement of the chain elements located between the individual parts of the chain elements on the one hand and between adjacent chain elements on the other hand, ensure that the size of this gap adds up to a considerable total gap length over the entire chain length. On the other hand, with the subject matter of the present invention, a massive or inherently stable and unyielding bar is provided that neither expands elastically nor has a run-in elongation, nor greater manufacturing tolerances or more extensive wear. By using the profiled bar, it is thus ensured that the aforementioned disadvantages of the prior art can be avoided.

A drive wheel interacts especially advantageously with the bar via a so-called drive gear. For this purpose, the drive wheel has several drive wheel elements arranged over its periphery which can be engaged with the bar to form the drive gear. Usually, the drive wheel elements of the drive wheel consist of pegs with inner bolts and outer bushings pivoted relative to the bolts and/or rollers.

Drive gears were used, for example, in the 19th century to drive mill spindles with a so-called lantern, however, are only used rarely since that time, possibly still for gear trains. In a drive gear, a gear wheel is usually engaged with a second wheel which has axial round pins or pegs as teeth. It is also known in the prior art to combine a gear wheel with a bar, wherein the bar is configured with drive shafts in a step-like manner.

On the other hand, with the subject matter of the present invention, the bar is configured in a conventional manner similar to a gear rack with teeth (i.e. not step-like), on the other hand, the gear wheel interacting with the bar has bolts or pegs instead of teeth which are constructed similar to bolts of chain elements, wherein the bolts are usually also provided with bushings and/or rollers to enable them to roll off along the teeth of the bar.

Accordingly, in the case of the present invention, the bar is stationary and the actuated gear wheel having the pegs or bolts is supported on the stationary bar. If the drive wheel is now set in rotation by a drive motor about a horizontal wheel axis, then the drive wheel rolls upward or downward along the bar, whereby the pegs or bolts which are distributed over the periphery of the drive wheel act in succession on the bar. As a result, the part of the lifting mechanism (which consists, in particular, of a load crosspiece) articulated on the drive wheel travels along the bar and thus along the rack in vertical direction.

On the whole, the lifting mechanism with drive gear according to the invention forms a system which more or less consists of the individual parts of a chain drive, however, in a modified arrangement and function: While the bar with the stationary teeth replaces the chain wheel otherwise used or is constructed similar to a linear unwinding of a chain wheel, the drive wheels with the pegs distributed over the periphery represents something like a short chain arranged in the form of a circle which interacts with the chain wheel unwinding.

However, since a large number of chain elements with gaps between the chain elements or chain element parts that add up is omitted, tolerances in the system of the lifting mechanism are reduced and the significant disadvantages of the prior art are avoided.

As is the case with chain elements, a gap for receiving lubricants can also be provided between bolts and bushing and/or roller of the drive wheel which ensures a low-maintenance and low-wear operation of the lifting mechanism.

As is also known in chains, e.g. in motorcycle chains, the lifting mechanism becomes even more low-maintenance in that an additional seal of the gap between bolt and bushing and/or roller is provided, which can occur, for example, by an additional O-ring or an equivalent seal.

With respect to the rest of the construction of the storage rack, it is provided according to the invention that the rack has at least two vertical rack supports which each support a bar. To this end, the bars parallel to one another and oriented in direction of the outer side of the rack unit where they can be acted upon by the drive wheels of the lifting mechanism. The drive wheels are hereby articulated at the end, in particular, to a load traverse extending in horizontal direction on both sides, whereby it must be ensured by suitable means that the load traverse on the rack unit is designed such that the drive wheels are always positioned relative to the bar in the exact horizontal position.

As a result, a lightweight construction of the rack unit can be provided in that the rack supports consist of two angled profiles bent in the shape of a U in the horizontal section and that the bar between the U-shaped profiles is fixed in position. As a result, a torsion-resistant break-resistant construction of the rack supports are produced without it being necessary for the material of the supports to be very thick. In rack supports without bars, a spacer is placed between the two profiled sections to obtain corresponding overall dimensions.

To enable a quiet travel of the lifting mechanism, it is provided according to the invention that the drive wheel is dimensioned such that at least two drive wheel elements each are simultaneously engaged with the bar. In this way, a climbing up or a rough jumping is prevented when a drive wheel element is unloaded and a subsequent drive wheel element loaded.

In a known manner, the bar has teeth protruding in horizontal direction, whereby the drive wheel elements sink between a tooth gap between two adjacent teeth to the bar end and roll off along the surface of the teeth when the bars are engaged.

According to the invention, it can be provided that the storage rack has not only one, but two (or even more) lifting mechanisms, for example, two lifting mechanisms arranged vertically above one another or two lifting mechanisms arranged on two opposite sides of the rack.

### BRIEF DESCRIPTION OF THE DRAWINGS

Further features and advantages of the present invention can be found in the dependent claims and in the following description of a preferred embodiment with reference to the drawings, showing:

FIG. 1 a storage rack according to the invention in a perspective front view;

FIG. 2 a drive wheel of a lifting mechanism according to the invention in a perspective side view;

FIG. 3 the drive wheel of FIG. 2 in a sectional perspective side view; and

FIG. 4 a rack support in a perspective sectional top view.

### DETAILED DESCRIPTION OF THE PREFERRED EMBODIMENT

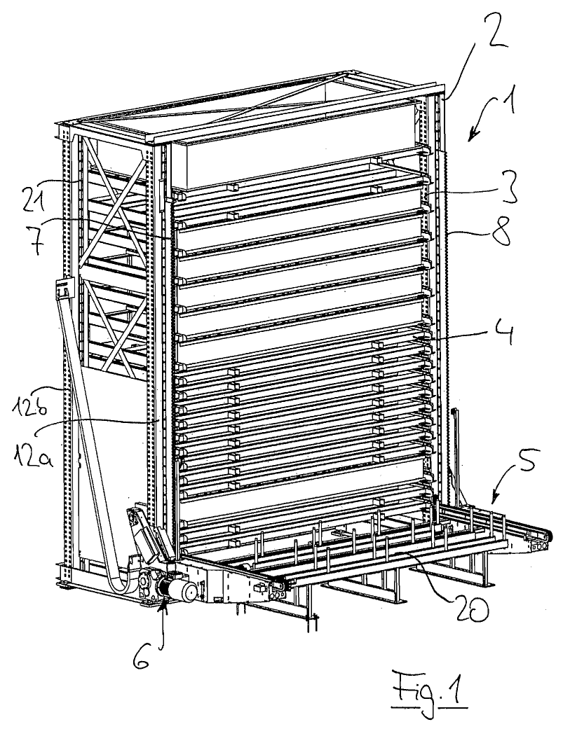

In FIG. 1, a storage rack 1 is shown with a rack unit 2 having several rack compartments 3 for receiving flat-shaped stock 4 which is placed in storage in the rack unit 2 parallel to one another in a horizontal plane and put in storage or removed from storage there.

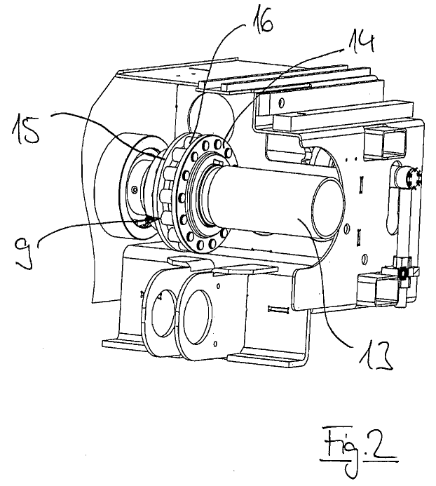

The putting into or removing from storage takes place via a rack control unit 5 which has a lifting mechanism 6 as an essential component with two vertical bars 7, 8 and with drive wheels 9 interacting with the bars (see FIG. 2) which are connected to one another via a load traverse 20 extending in horizontal direction.

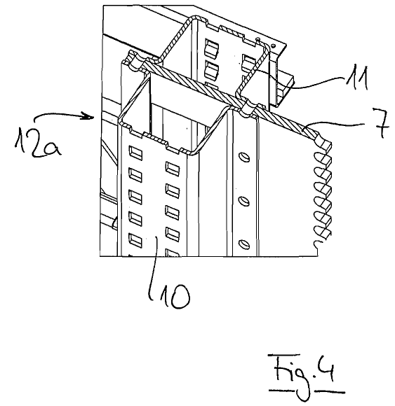

As can be seen in FIG. 4, the bars 7, 8 are fixed in position between two profiled sections 10, 11 bent in the shape of a U in the horizontal section and are thus break-resistant, on the one hand, and resistant to torsion on the other hand. The two U-shaped profiles 10, 11, together with a bar 7, 8 each, form a rack support 12a or together with a spacer 21, which advantageously has the same thickness as a bar, a rack support 12b, whereby the rack unit 2 has, as a whole, two vertical front rack supports 12a, arranged parallel to one another, and two vertical rear rack supports 12b, arranged parallel to one another.

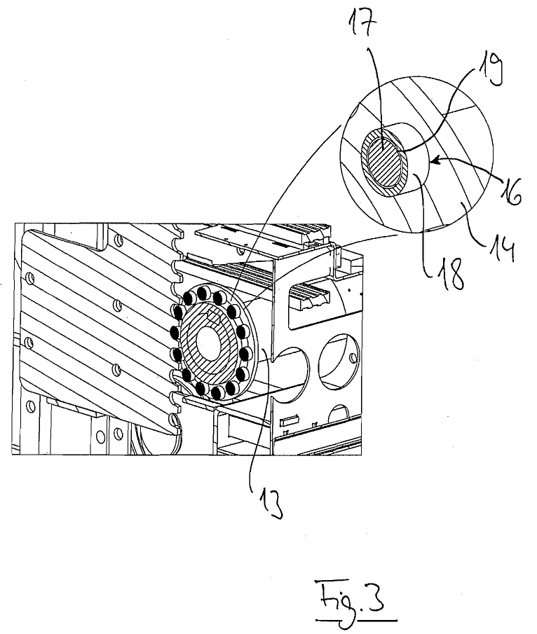

The exact construction of the drive wheel 9 essential to the invention can be found in FIGS. 2 and 3: One can see here that a drive shaft 13, which transmits a rotational movement from one drive motor (not shown) to the drive wheel 9 is attached so as to be resistant to torsion and in this way transfers the drive movement to the drive wheel. In particular, the drive wheel consists of two side disks 14, 15 which extend in a vertical plane. A large number of pegs 16 extending in horizontal direction with a horizontal axis are arranged between the side disks, said pegs consisting of inner bolts 17 and outer bushings 18, a gap 19 being left between each bolt 17 and bushing 18 to receive lubricants.

The bushing 18 can turn about the horizontal axis of the bolt vis-à-vis the bolt 17 and can, in this way, roll off on the teeth of the bar 7 or 8, respectively.

In summary, the present invention offers the advantage of working with a fixed reference component, namely with an unyielding bar, which results therein that neither elastic elongations nor wear nor run-in elongations, etc. result in a deviation of the respective position of the lifting mechanism in comparison to the rack unit.

1. A storage rack for flat-shaped stock (4), comprising at least one rack unit (2) which has several rack compartments arranged above one another to receive the stock (4), at least one rack control unit for placing the stock in storage or for removing it, the rack control unit is arranged so as to be vertically adjustable relative to the rack unit and has a lifting mechanism (6) for vertical adjustment, the lifting mechanism (6) has at least one bar (7, 8) extending generally in a vertical direction, allocated to the rack unit (2), and a drive wheel (9) allocated to the vertically adjustable rack control unit, and the drive wheel (9) interacts with the bar (7, 8) via a drive gear.

2. The storage rack according to claim 1, wherein the drive wheel (9) has several drive wheel elements (16) arranged about a periphery thereof which can be engaged with the bar (7, 8) to form the drive gear.

3. The storage rack according to claim 1, wherein the drive wheel (9) has a horizontal wheel axis and the drive wheel can be set into rotation about the wheel axis to produce the lift movement of the lifting mechanism (6) by a drive motor and moved along the bar (7, 8) in the vertical direction.

4. The storage rack according to claim 2, wherein the drive wheel elements (16) of the drive wheel (9) have a horizontal axis.

5. The storage rack according to claim 2, wherein the drive wheel elements (16) of the drive wheel (9) comprise pegs having inner bolts (17) and outer bushings, pivotable relative to the bolts (18) or rollers.

6. The storage rack according to claim 5, wherein a gap (19) is provided for receiving lubricants between each of the bolts (17) and the bushings (18) or rollers.

7. The storage rack according to claim 1, wherein the rack unit (2) has at least two vertical rack supports (12a) which each support one of the bars (7, 8).

8. The storage rack according to claim 7, wherein the rack supports (12a) include two profiled sections (10, 11) bent in a U-shape in a horizontal section and the bar (7, 8) is fixed between the profiled bars.

9. The storage rack according to claim 2, wherein the drive wheel (9) is dimensioned such that at least two of the drive wheel elements (16) are engaged with the bar (7, 8).

10. The storage rack according to claim 2, wherein the bar (7, 8) has teeth projecting in a horizontal direction and the drive wheel elements (16) sink into the bar between a tooth gap between two adjacent teeth to a bar base and roll off along a surface of the teeth.
